(19) United States
(12) Patent Application Publication
(10) Pub. No.: US 2004/0003085 A1
(43) Pub. Date: Jan. 1, 2004

(54) Active application socket management

(76) Inventors: Paul G. Joseph, Boxboro, MA (US); Sanjeev Nandan, Lawrence, MA (US); Suyash K. Apte, Maharashtra (IN); Deepa Saini, Maharashtra (IN)

Correspondence Address: ROPES & GRAY LLP, ONE INTERNATIONAL PLACE, BOSTON, MA, 02110-2624, US

(21) Appl. No.: 10/184,396

(22) Filed: Jun. 26, 2002

(51) Int. Cl. G06F 15/16

(52) U.S. Cl. 709/226; 709/228

(57) ABSTRACT

Methods and systems are disclosed that effectively manage sockets in client-to-server connections at the application level to enhance the availability of sockets by timely closing idle sockets. This reduces the role of the TCP-level management to a single listen thread on a listen socket. Connected sockets are placed into the application's socket pool that is managed by a configurable number of worker threads. The proposed methods and systems are intended to prevent a situation where many connections are opened, thereby using all the network memory on the machine.

### FIELD OF THE INVENTION

The invention is directed to managing client-to-server connections in a network environment, and more particularly to actively managing sockets in client-to-server connections at the application level to enhance the availability of sockets by timely closing idle sockets.

### DESCRIPTION OF THE RELATED ART

In the design of high performance servers, an application or daemon may have to handle large numbers of requests from client(s) over TCP/IP sockets. Typically socket management—socket pooling, dispatch of sockets with data to the main program/daemon and closing the sockets—is done by the “listen” thread, which manages its own pool of sockets and sets options provided by TCP to manage the sockets.

Such systems are described, for example, in “TCP/IP Illustrated”, Vol. 1-3, Addison-Wesley Pub Co., Professional Computing Series, 1994-1996, which are hereby incorporated by reference herein in their entirety. The TCP/IP protocol and related socket management is also described in “AIX Version 4.3 Communications Programming Concepts” available online at www.unet.univie.ac.at/aix/aixprggd/progcomc/edition.htm. This online publication is also incorporated herein by reference in its entirety.

Sockets provide the application program interface (API) to the communication subsystem. There are several types of sockets that provide various levels of service by using different communication protocols. Sockets of type SOCK_DGRAM use the UDP protocol. Sockets of type SOCK_STREAM use the TCP protocol. The semantics of opening, reading, and writing to sockets are similar to those for manipulating files.

As an application writes to a socket, the data is copied from user space into the socket send buffer in kernel space. Depending on the amount of data being copied into the socket send buffer, the socket puts the data into either small buffers or larger buffers. Once the data is copied into the socket send buffer, the socket layer calls the transport layer (either TCP or UDP), passing it a pointer to the linked list of buffers.

On the receive side, an application opens a socket and attempts to read data from it. If there is no data in the socket receive buffer, the socket layer causes the application thread to go to the sleep state (blocking) until data arrives. When data arrives, it is put on the receive socket buffer queue and the application thread is made dispatchable, i.e., woken up. The data is then copied into the application's buffer in user space, the receive buffer chain is freed, and control is returned to the application.

In a conventional architecture, the server does not know when a client connection is no longer needed. The standard approach is to use TCP options for setting a time for the socket to live. Socket shutdown is described, for example, in “AIX Version 4.3 Communications Programming Concepts” referenced above. Because it is implemented in the TCP layer of the Operating System (OS), the application programmer cannot access it to close the socket. Also, if the client simply is present and keeps the socket open, then this approach does not actively close the socket. As a result, the number of open sockets can keep growing, causing the system to run out of resources.

It would therefore be desirable to provide an architecture wherein the open sockets can be actively monitored and a socket that remains free of data for a certain configurable period of time is closed. This would prevent the number of open sockets from increasing and the system from exhausting its resources.

### SUMMARY

Active application socket management is a method of controlling and configuring sockets, such as TCP/IP sockets, for use by an application program that manages the socket pool at the application level rather than at the server level. This approach provides more control granularity and efficiency by minimizing the number of inactive sockets left open and the amount of listener thread overhead (i.e., server process resources) needed to manage the socket pool. Additionally, the availability of sockets to client applications is optimized by this method, providing new sockets faster and with less overhead and more responsive client interaction.

According to one aspect of the invention, a method for managing socket allocation in a client-server system includes receiving a connection request; providing a socket for the connection request; and placing the socket in a socket pool. The method further includes a plurality of worker threads, with a worker thread from the plurality of worker threads removing the socket from the socket pool and reading data transmitted on the socket between the client and the server. The worker thread then returns the socket to the socket pool. If additional data is received on the returned socket before expiration of a configurable time period, another worker thread picks up the socket from the socket pool. Conversely, if no additional data is received on the returned socket before expiration of the configurable time period, the socket is closed.

According to another aspect of the invention, a computer system for use in managing socket allocation in a client-server environment is provided, with the computer system including computer instructions to carry out the method of managing socket allocation in a client-server system.

According to yet another aspect of the invention, a computer-readable medium is provided that stores a computer program executable by at least one server computer, wherein the computer program includes computer instructions for carrying out the method of managing socket allocation in a client-server system.

Embodiments of the invention may include one or more of the following features. The plurality of worker threads can have a configurable number of worker threads that continuously monitor the socket pool. The configurable number of worker threads can be independent of the number of open sockets, so that even a single socket can be monitored by several worker threads. The worker thread that picks up the socket with data from the socket pool processes said read data and returns to an idle state after processing said read data. A listener thread, preferably a single listener thread, can be provided that monitors the connection requests and places said socket associated with a corresponding connection request in the socket pool.

The methods and systems of the invention have the advantage that once the listener thread/process hands the socket over to the worker process/threads, it has nothing further to do with it. As a result, the overhead of the listener thread/process is decreased, making it more efficient to monitor requests to the published port, thereby improving the responsiveness of the system to the client. The worker processes/threads for their part make the socket available to the client as soon as there is no data left to read from it, and then monitor the socket. This eliminates the need to hand the socket back to the listener thread/process, thereby improving efficiency.

### BRIEF DESCRIPTION OF THE DRAWINGS

The present disclosure may be better understood and its numerous features and advantages made apparent to those skilled in the art by referencing the accompanying drawings.

FIG. 1 is a block diagram of a client/server architecture in a network;

FIG. 2 is an exemplary stack of TCP/IP layers in a typical network application;

FIG. 3 is a block diagram of an exemplary socket architecture of the invention;

FIG. 4 is a schematic flow diagram for active application socket management according to an embodiment of the invention; and

FIG. 5 is a prior art socket management process at the TCP level.

The use of the same reference symbols in different drawings indicates similar or identical items.

### DETAILED DESCRIPTION OF CERTAIN ILLUSTRATED EMBODIMENTS

The methods and systems described herein are directed to active management of sockets in client-server environments at the application level. In this way, in a high performance environment, the server can: a) actively close idle sockets without relying on TCP options; b) optimize socket availability to the client by making sockets available to the client faster; c) reduce the overhead needed to manage sockets, and—as a result—d) be more responsive to client interactions.

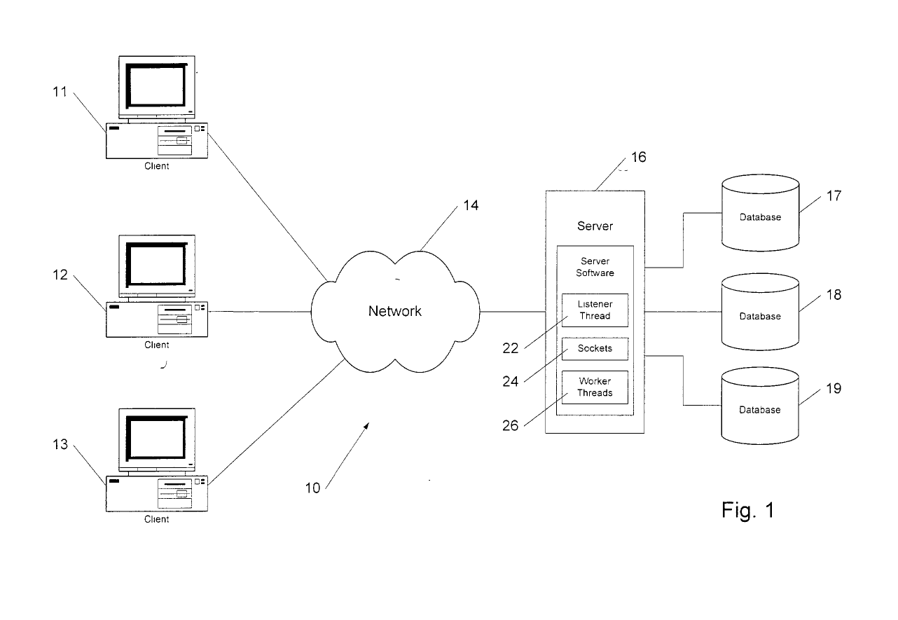

FIG. 1 is a block diagram of a system 10 for connecting clients to databases via the internet. The system 10 includes clients 11, 12, and 13. The clients 11, 12, and 13 are coupled with a server 16 via a network 14, such as the Internet. To access information through the server 16, the client 11, 12, or 13 sends a request (not shown) to the server 16. The server 16 can include server software with run time structures that include a listener thread 22, a plurality of sockets 24 and a plurality of worker threads 26. The listener thread 22 listens for incoming client requests. Each worker thread 26 aids in processing an incoming request. The server 16 is typically coupled to databases 17, 18, and 19, each holding information.

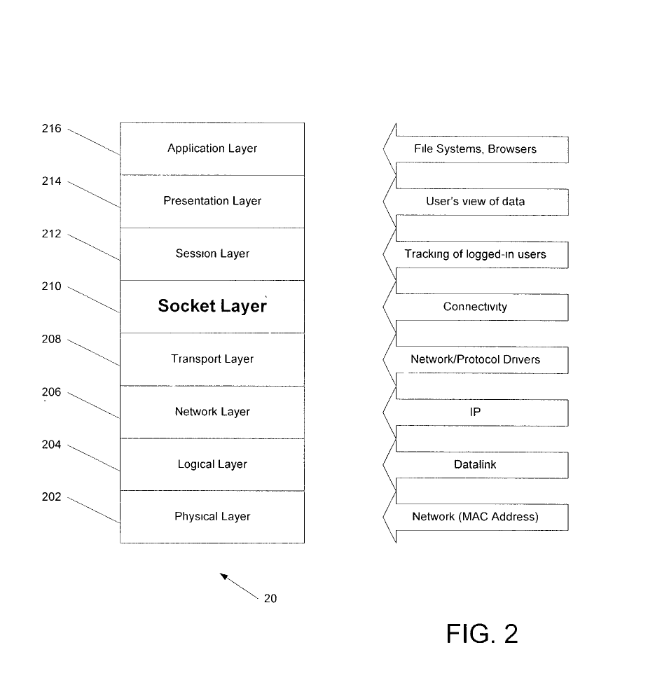

Internet connectivity has become the norm for many systems, and TCP/IP (Transaction Control Protocol and Internet Protocol) is the core technology for this connectivity. FIG. 2 shows an exemplary stack 20 of TCP/IP layers in a typical network application. The principle behind layering is that each layer hides its implementation details from the layers below and the layers above. Each layer on the transmitting machine has a logical client-to-server connection with the corresponding layer in the receiving machine. Each layer in the system receives frames from the layer below and transmits frames to the layer above.

The physical layer 202 encompasses the actual physical data transmission. Examples are Ethernet (CSMA/CD) or Token Ring for LAN applications, or various high-speed serial interfaces for WANs. Physical layer implementation is specific to the type of transmission. The logical layer 204 isolates the layers above from the physical and electrical transmission details. It is responsible for presenting an interface for an error-free transmission by filtering packets and frames. The network layer 206 encompasses the Internet domain knowledge. It contains the routing protocols for routing of packets across network interfaces, and it understands the Internet addressing scheme (Internet Protocol (IP)). Domain naming and address management are considered to be part of this layer as well. IP also includes a mechanism for fragmentation and reassembly of packets that exceed the link layer's maximum transmission unit (MTU) length.

The transport layer 208 implements reliable sequenced packet delivery known as connection-oriented transfer. This layer incorporates retrying and sequencing necessary to correct for lost information at the lower layers. The transport for TCP/IP actually includes two protocols: TCP for reliable or connection-oriented transmission, and UDP for a less reliable, connectionless transmission. In the TCP socket layer 210, the sockets are received and transmitted full duplex and buffered. A socket can be thought of as a mated pair of logical endpoints. One endpoint is on the sending machine and one is on the receiving machine. The application in the transmitting machine can write an undifferentiated stream of data in the socket as if it were a pipe and the application on the receiving machine will receive the same data in the same order.

The upper layers 212, 214, 216 of the network architecture include the session layer 212 which was originally conceived to support virtual terminal applications between remote login terminals and a central terminal server, and the presentation layer 214 which maps the user's view of the data as a structured entity to the lower layer protocol's view as a stream of bytes. Because TCP/IP only incorporates protocols from the physical through the transport layer, all the software above the transport layer is generally lumped together as networking applications. The session layer 212 and presentation layer 214 are therefore not differentiated from the application layer 216.

The top application layer 216 encompasses virtually all applications of TCP/IP network management, including network file systems, web server or browser, or client server transaction protocols.

Data travels from the application layer 216 of the sending machine down the stack 20, out the physical layer 202, and up the corresponding stack of the receiving machine. The application or user layer 216 first creates a socket and writes the data into the socket.

In the Internet domain, the server process creates a socket, using in some embodiments socket, bind, and listen subroutines, then binds the to socket a protocol port by assigning a Name parameter to the socket, and waits for requests. Most of the work performed by the socket layer is in sending and receiving data. Sockets can be set to either blocking or nonblocking I/O mode. The socket layer itself explicitly refrains from imposing any structure on data transmitted or received through sockets.

Many versions of standard C Libraries that are well known to programmers of ordinary skill in the art, contain the subroutines for performing the socket operations.

The listen subroutine is outlined below:

#include <sys/types.h>
#include <sys/socket.h>
#include <netinet/in.h>
int listen (Socket, Backlog)
int Socket, Backlog;

and performs the following activities:

Identifies the socket that receives the connections.

Marks the socket as accepting connections.

Limits the number of outstanding connection requests in the system queue.

The listen subroutine has the parameters:

| | |
|---|---|
| Socket: | Specifies the unique name for the socket. |
| Backlog: | Specifies the maximum number of outstanding connection |
| | requests. |

Upon successful completion, the listen subroutine returns to the calling program a value 0; otherwise a value of −1 or an error code.

The server waits for a connection by using the accept subroutine. A call to the accept subroutine blocks further processing until a connection request arrives. When a request arrives, the operating system returns the address of the client process that has placed the request.

The accept subroutine is outlined below:

int accept (Socket, Address, AddressLength)
int Socket;
struct sockaddr *Address;
size_t *AddressLength;

When a connection is established, the call to the accept subroutine returns. The server process can either handle requests interactively or concurrently. In the interactive approach, the server handles the request itself, closes the new socket, and then starts the accept subroutine to obtain the next connection request. In the concurrent approach, after the call to the accept subroutine returns, the server process forks a new process to handle the request. The new process inherits a copy of the new socket, proceeds to service the request, and then exits. The original server process must close its copy of the new socket and then invoke the accept subroutine to obtain the next connection request.

Once a connection is established between sockets, an application program can send and receive data. Once a socket is no longer required, the calling program can discard the socket by applying a close or shutdown subroutine to the socket descriptor:

#include <unistd.h>

int close (
FileDescriptor)

int FileDescriptor;

Instead of a close subroutine, a shutdown subroutine can be invoked:

int shutdown (Socket, How)
int Socket, How;

The parameter How specifies the type of subroutine shutdown. The shutdown subroutine disables all receive and send operations on the specified socket.

Closing a socket and reclaiming its resources is not always a straightforward operation. In conventional systems, sockets are managed by the listener thread. The listener thread then assigns active sockets to worker threads. A given worker thread services only one particular client. When a packet is received by the receiving machine, it is placed on the receiving machine's socket input queue (or queues, in the case of multicasting). If there is no data in the socket receive buffer, the socket layer causes the application thread to go to the sleep state (blocking) until data arrives. The server hence does not know when a client connection is no longer needed. As a result, the number of open sockets can keep growing, causing the system to run out of resources. In the proposed architecture, the application program actively monitors the socket and closes the socket if the socket remains free of data for a certain configurable period of time. This prevents the number of open sockets from growing and causing the system to run out of resources.

A socket threshold value can be defined that determines how much of the system's network memory can be used before socket creation is disallowed. The socket threshold option is intended to prevent a situation where many connections are opened, thereby using all the network memory on the machine. This would leave no memory for other operations, resulting in a hang. The machine must then be rebooted to recover. The socket threshold is typically set to the point above which new sockets should no longer be allowed. Calls to sockets and socket pairs will fail and incoming connection requests will be silently discarded. This results in an architecture that is not ideal for a high performance environment.

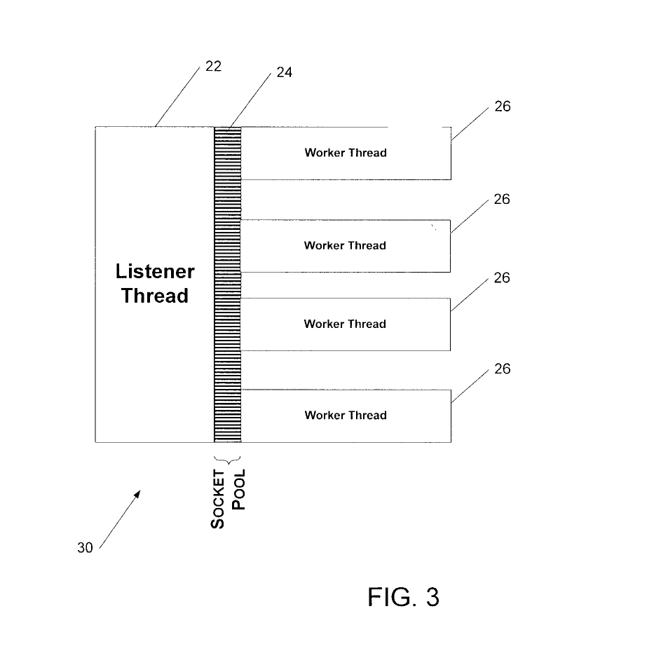

Referring now to FIG. 3, an exemplary application-level-managed socket architecture 30 includes a listener thread 22 that listens on a listener socket (not shown) for connection requests to a server running, for example, under the TCP/IP protocol. The connection requests are serviced by sockets which are placed (or “enqueued”) in a socket pool/queue 24. The sockets in the socket pool 24 are operated on by a plurality of worker threads 26 in a manner described in detail below. Worker threads can accomplish a wide variety of tasks, for example, offloading processing of certain types of requests, such as access to the databases 17, 18, 19 depicted in FIG. 1, so that the primary threads, and in particular the listener thread, can remain available for other server requests.

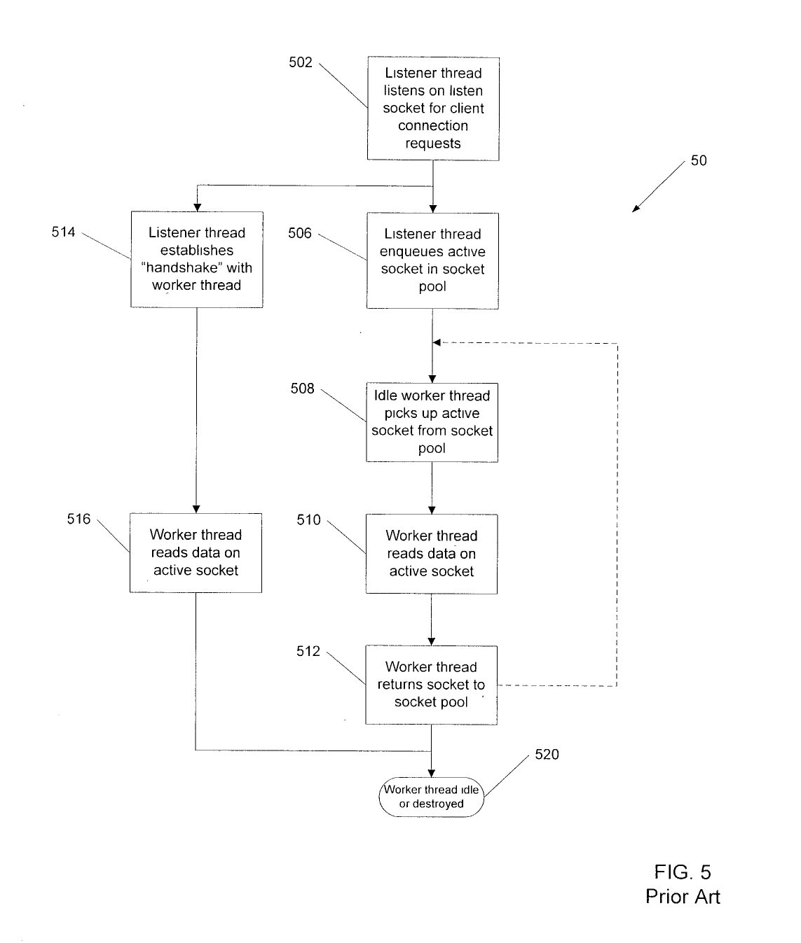

The listener thread 22 monitors only the listener socket and passes active sockets, i.e., sockets on which data are received, to a socket pool or socket queue where the active sockets are serviced by the worker threads 26. A configurable number of worker threads each tests if data are present on a socket. A particular software routine called WorkQueue Class can ensure that no two workers simultaneously attempt access to the same socket. Once the listener thread 22 hands the socket over to the socket queue, the worker threads take over and the listener thread has nothing further to do with the client/server connection. As a result, its overhead is decreased, and the listener thread 22 is able to monitor requests more efficiently, thereby improving the responsiveness of the system to the client. The worker threads then return the socket to the socket pool 24 as soon as there is no data to be read left in the socket, and then continue to monitor the sockets in the socket queue for activity. This eliminates the need to hand the sockets back to the listener thread 22, as is done in conventional socket management processes described above. A prior art process is described below with reference to FIG. 5.

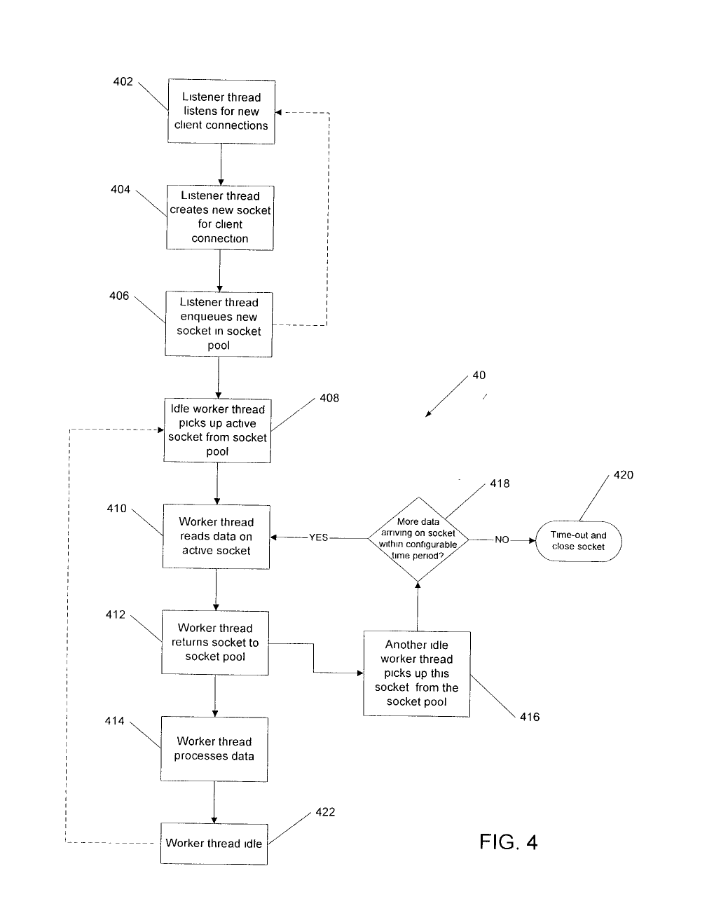

Referring now to FIG. 4, in an exemplary process 40 for application-based active socket management, the listener thread 22 listens for new connections from a client, step 402. Whenever a client establishes a new connection or reestablishes a connection, the listener thread 22 accepts the connection and creates a new socket for the connection, step 404. The listener thread 22 then enqueues the new socket in the socket pool 24, step 406, and returns to step 402 to accept new connections. The listener thread 22 manages only one socket, which is the listening socket the listening thread is listening on. The sockets in the socket pool are all active sockets. One of the worker threads 26 picks up an active socket that is enqueued in the socket pool, step 408, and reads the data on the active socket, step 410. When all data on the socket have been read out, the worker thread returns the socket to the socket pool, step 412. The worker thread that read the data on the socket then processes the data, step 414, whereafter that worker thread becomes idle, step 422, and returns to step 408 to rejoin the worker threads that monitor the socket pool.

After the socket is returned to the socket pool in step 412, the group of worker threads 26 continue to monitor the socket, with another idle worker thread picking up the socket, step 416, and waiting for new data to arrive during a configurable time period, step 418. If the monitoring worker thread determines in step 418, that there are no more data in the socket and a read fails, then the socket times out and the worker threads actively close the socket, step 420. Conversely, if the worker thread in step 418 detects additional data on the socket, then the process returns to step 410, with the worker thread reading the additional data on the socket.

In summary, a worker thread picks up a socket from a socket pool, reads the data, returns the socket to the pool and then processes the data. This allows any idling worker thread to immediately pick up this socket and read any data on it. All socket management is done at the application level in this architecture.

For comparison, in a prior art process 50 shown in FIG. 5, sockets are managed by the listener thread rather than the worker threads. All sockets are monitored by the listener thread for data, step 502. When the listener thread detects that a socket has data on it (active socket), the listener thread hands the active socket over to a worker thread by one of several possible methods, including enqueuing the active socket in a socket pool, step 506, or by directly establishing a handshake with the worker thread, step 514. In the former case, an idle worker thread picks up the enqueued active socket, step 508, and reads the data on the active socket, step 510. The worker thread then returns the now empty socket to the set of sockets managed by the listener thread, step 512. In the latter case, where there is no socket pool, the worker thread reads the data on the active socket, step 516. In both cases, the worker thread is subsequently either idled or destroyed, step 520. The listener thread continues to monitor all the available sockets. The listener thread hence has the overhead of monitoring all the sockets and of handing over the socket with data to be processed to the worker threads and of closing the socket if the client closes the connection. The listener thread does not close an individual socket if the socket is idle.

Unlike the socket pool architecture of FIG. 5, the proposed application-level socket pool architecture depicted in FIG. 4 allows the active closure of any open but inactive socket without any performance or overhead impact. By closing open but inactive sockets, memory and resources are conserved, providing active protection against a poorly coded or malicious client program. In addition, multiple threads (instead of a single listener thread) can monitor sockets for data, thus freeing up the listener thread to concentrate on accepting connections from clients. Performance is further optimized and complexity minimized by not returning the socket back to the listener thread's socket pool, and the load is distributed across all worker threads even if there is only a single client.

It should be noted that this type of architecture requires that the clients check for half closed connections before writing to the socket in order to determine that the connection to the server is valid. If it is not valid, the client needs to reconnect. This is required only for persistent connections where periods of inactivity may have occurred during which the server may have closed the connection to the client.

On Shutdown, the listener thread exits first. Then worker threads exit after processing all log records available in the enqueued sockets.

The method of the present invention may be performed in either hardware, software, or any combination thereof, as those terms are currently known in the art. In particular, the present method may be carried out by software, firmware, or microcode operating on a computer or computers of any type. Additionally, software embodying the present invention may comprise computer instructions in any form (e.g., source code, object code, interpreted code, etc.) stored in any computer-readable medium (e.g., ROM, RAM, magnetic media, punched tape or card, compact disc (CD) in any form, DVD, etc.). Furthermore, such software may also be in the form of a computer data signal embodied in a carrier wave, such as that found within the well-known Web pages transferred among devices connected to the Internet. Accordingly, the present invention is not limited to any particular platform, unless specifically stated otherwise in the present disclosure.

While particular embodiments of the present invention have been shown and described, it will be apparent to those skilled in the art that changes and modifications may be made without departing from this invention in its broader aspect and, therefore, the appended claims are to encompass within their scope all such changes and modifications as fall within the true spirit of this invention.

We claim:

1. A method for managing socket allocation in a client-server system, comprising:
(a) providing a listener thread for monitoring connection requests to the server;
(b) the listener thread receiving a connection request and providing a socket for said connection request;
(c) the listener thread placing said socket in a socket pool;
(d) providing a plurality of worker threads monitoring said socket pool;
(e) a worker thread removing said socket from the socket pool and reading data transmitted on said socket between the client and the server;
(f) the worker thread returning said socket to the socket pool; and
(g) if additional data is received on said returned socket before expiration of a configurable time period, returning to step (e); and
(h) if no additional data is received on said returned socket before expiration of the configurable time period, the worker thread closing said socket.

2. The method of claim 1, wherein said plurality of worker threads has a configurable number of worker threads.

3. The method of claim 1, wherein said plurality of worker threads continuously monitors the socket pool.

4. The method of claim 2, wherein said configurable number of worker threads is independent of the number of open sockets.

5. The method of claim 1, further comprising the worker thread processing said read data and returning to an idle state after processing said read data.

6. The method of claim 1, the listener thread returning to step (b) after placing said socket in the socket pool.

7. A computer system for use in managing socket allocation in a client-server environment, comprising computer instructions for:
(a) providing a listener thread for monitoring connection requests to the server;
(b) causing the listener thread to provide a socket when the listener thread receives said connection request;
(c) causing the listener thread to place said socket in a socket pool;
(d) providing a plurality of worker threads monitoring said socket pool;
(e) causing a worker thread to remove said socket from the socket pool and read data transmitted on said socket between the client and the server;
(f) causing the worker thread to return said socket to the socket pool; and
(g) if additional data is received on said returned socket before expiration of a configurable time period, returning to step (e); and
(h) if no additional data is received on said returned socket before expiration of the configurable time period, causing the worker thread to close said socket.

8. The computer system of claim 7, wherein said computer instructions further cause the worker thread to process said read data and return to an idle state after processing said read data.

9. The computer system of claim 7, wherein said computer instructions further cause the listener thread to return to monitoring connection requests to the server after placing said socket in the socket pool.

10. A computer-readable medium storing a computer program executable by at least one server computer, the computer program comprising computer instructions for:
(a) providing a listener thread for monitoring connection requests to the server;
(b) causing the listener thread to provide a socket when the listener thread receives said connection request;
(c) causing the listener thread to place said socket in a socket pool;
(d) providing a plurality of worker threads monitoring said socket pool;
(e) causing a worker thread to remove said socket from the socket pool and read data transmitted on said socket between the client and the server;
(f) causing the worker thread to return said socket to the socket pool; and
(g) if additional data is received on said returned socket before expiration of a configurable time period, returning to step (e); and
(h) if no additional data is received on said returned socket before expiration of the configurable time period, causing the worker thread to close said socket.

12. The computer computer-readable medium of claim 10, wherein said computer instructions further cause the worker thread to process said read data and return to an idle state after processing said read data.

13. The computer computer-readable medium of claim 10, wherein said computer instructions further cause the listener thread to return to monitoring connection requests to the server after placing said socket in the socket pool.
